(19) United States
(12) Patent Application Publication
(10) Pub. No.: US 2015/0215247 A1
(43) Pub. Date: Jul. 30, 2015

(54) SELECTING A COMMUNICATION MODE

(71) Applicant: applicant

(72) Inventor: Saumil Ashvin Gandhi, Sunnyvale, CA (US)

(21) Appl. No.: 14/585,091

(22) Filed: Dec. 29, 2014

Related U.S. Application Data
(60) Provisional application No. 61/932,092, filed on Jan. 27, 2014.

(51) Int. Cl. H04L 12/58; H04L 29/08

(52) U.S. Cl. CPC H04L 51/046; H04L 67/02

(57) ABSTRACT

Systems and methods to switch from a first communication mode to a second communication mode are disclosed herein. A level of communication between a first user and a second user in a first communication mode is detected. The first communication mode is included in a first communication interface displayed on a device of the first user. A second communication mode is selected based on the detected level of communication between the first user and the second user in the first communication mode. A switch from the first communication mode to the second communication mode is caused. The second communication mode is included in a second communication interface.

### RELATED APPLICATION

This patent application claims the benefit of priority, under 35 U.S.C. §119(e), to Saumil Ashvin Gandhi, U.S. Provisional Patent Application Ser. No. 61/932,092, entitled “SELECTING A COMMUNICATION MODE,” filed on Jan. 27, 2014 (Attorney Docket No. 2043.F36PRV), which is hereby incorporated by reference herein in its entirety.

### TECHNICAL FIELD

The subject matter disclosed herein generally relates to data presentation. Specifically, the present disclosure addresses systems and methods to facilitate a switch from a first communication mode to a second communication mode.

### BACKGROUND

A user may select or choose from various communication modes in order to communicate with another user. For example, the user may choose to write an email message to a friend. As another example, the user may choose to write a text message that is sent to a friend. Moreover, each of these communication modes may be displayed within a user device as part of a communication interface.

### BRIEF DESCRIPTION OF THE DRAWINGS

Some embodiments are illustrated by way of example and not limitation in the figures of the accompanying drawings.

FIG. 1 is a network diagram illustrating a network environment suitable for causing a switch from a first communication mode to a second communication mode, according to some example embodiments.

FIG. 2 is a block diagram illustrating components of a server machine suitable for causing a switch from a first communication mode to a second communication mode, according to some example embodiments.

FIG. 3-6 are example user interfaces displaying a communication interface, according to some example embodiments.

FIG. 7-9 are flowcharts illustrating operations of a server machine in performing a method of causing a switch from a first communication mode to a second communication mode, according to some example embodiments.

FIG. 10 is a block diagram illustrating components of a machine, according to some example embodiments, able to read instructions from a machine-readable medium and perform any one or more of the methodologies discussed herein.

### DETAILED DESCRIPTION

Example methods and systems are directed to causing a switch from a first communication mode to a second communication mode. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

A first user may communicate with a second user in a first communication mode displayed in a first communication interface. As an example the first user may send an email to the second user. Depending on a level of communication between the first and second users, a system as described herein may cause a switch from the first communication mode to a second communication mode. For example, if a conversation results from the email and numerous responses are sent back and forth between the first and second user within an email interface, the system may detect this activity and cause a switch from the email interface to a messaging service. As another example, if the users are communicating over the messaging service and a business-related conversation is detected as part of their communication, the system may cause the messaging service to switch to email by display an email interface of a business email account which is more suitable for the conversation. This may reduce a burden on behalf of the user of having to manually switch between communication modes. This may also reduce a burden on behalf of the user of having to begin a new conversation in a new communication mode. In other words, the user is able to continue the conversation with the second user without having to refer back to contents of the conversation in the previous communication mode.

Accordingly, one or more of the methodologies discussed herein may obviate a need for manually switching communication interfaces, which may have the technical effect of reducing computing resources used by one or more devices within the system. Examples of such computing resources include, without limitation, processor cycles, network traffic, memory usage, storage space, and power consumption.

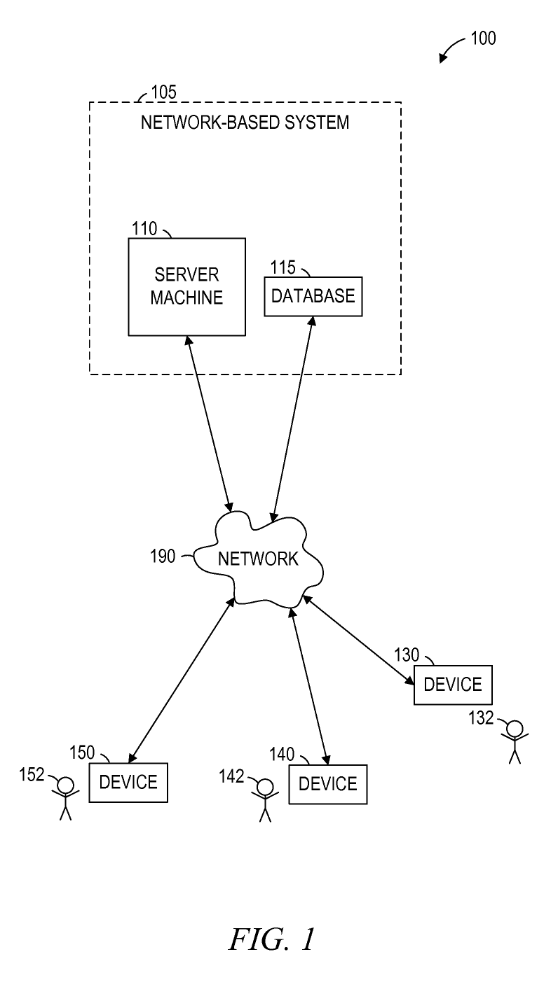

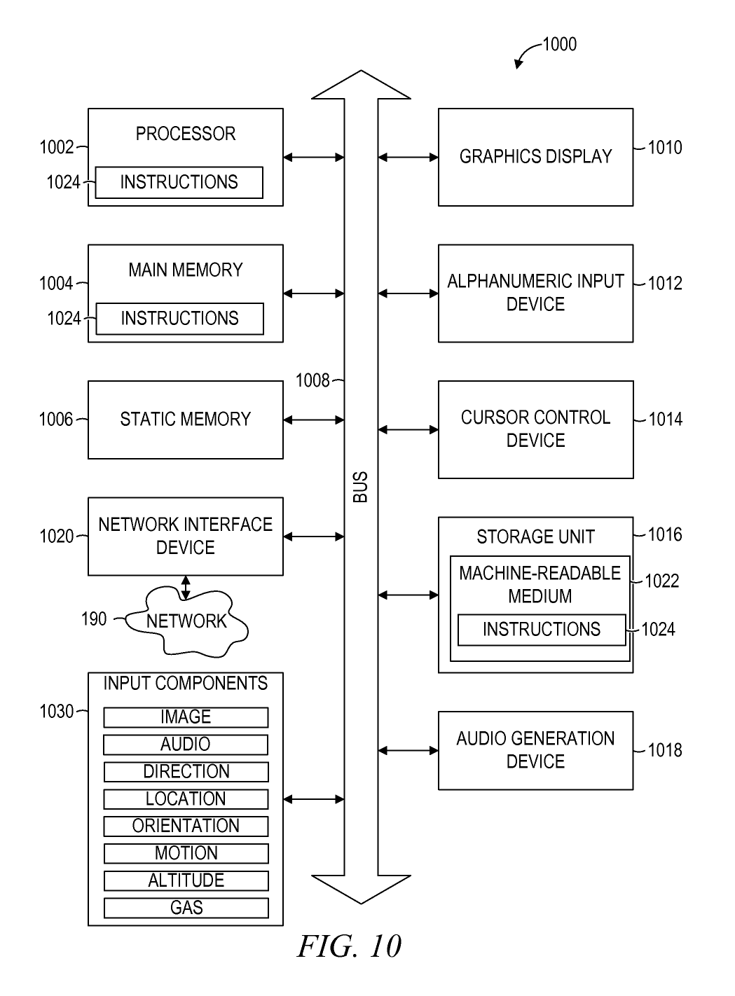

FIG. 1 is a network diagram illustrating a network environment 100 suitable for causing a switch from a first communication mode to a second communication mode, according to some example embodiments. The network environment 100 includes a server machine 110, a database 115, and devices 130 and 150, all communicatively coupled to each other via a network 190. The server machine 110 may form all or part of a network-based system 105 (e.g., a cloud-based server system configured to provide one or more services to the devices 130 and 150). The server machine 110 and the devices 130 and 150 may each be implemented in a computer system, in whole or in part, as described below with respect to FIG. 10.

Also shown in FIG. 1 are users 132, 142, and 152. Any of the users 132, 142, 152 may be a human user (e.g., a human being), a machine user (e.g., a computer configured by a software program to interact with the device 130), or any suitable combination thereof (e.g., a human assisted by a machine or a machine supervised by a human). The user 132 is not part of the network environment 100, but is associated with the device 130 and may be a user of the device 130. For example, the device 130 may be a desktop computer, a vehicle computer, a tablet computer, a navigational device, a portable media device, a smartphone, or a wearable device (e.g., a smart watch or smart glasses) belonging to the user 132. Likewise, the users 142, and 152 each is not part of the network environment 100, but is associated a device. As shown, the user 142 is associated with device 140 and the user 152 is associated with the device 150. As an example, each of the devices 140 and 150 may be a desktop computer, a vehicle computer, a tablet computer, a navigational device, a portable media device, a smartphone, or a wearable device (e.g., a smart watch or smart glasses) belonging to the users 142 and 152.

Each of the users 132, 142, and 152 may be conversing with one another using their respective devices 130, 140, and 150. Further, the conversation may be performed using a communication mode that is displayed on the devices 130, 140, and 150. Also, any communications exchanged during the conversation between the users 132, 142, and 152 may be sent over the network 190.

Any of the machines, databases, or devices shown in FIG. 1 may be implemented in a general-purpose computer modified (e.g., configured or programmed) by software (e.g., one or more software modules) to be a special-purpose computer to perform one or more of the functions described herein for that machine, database, or device. For example, a computer system able to implement any one or more of the methodologies described herein is discussed below with respect to FIG. 10. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines, databases, and devices (e.g., the server machine 110 and the device 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 190 may communicate information via a transmission medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

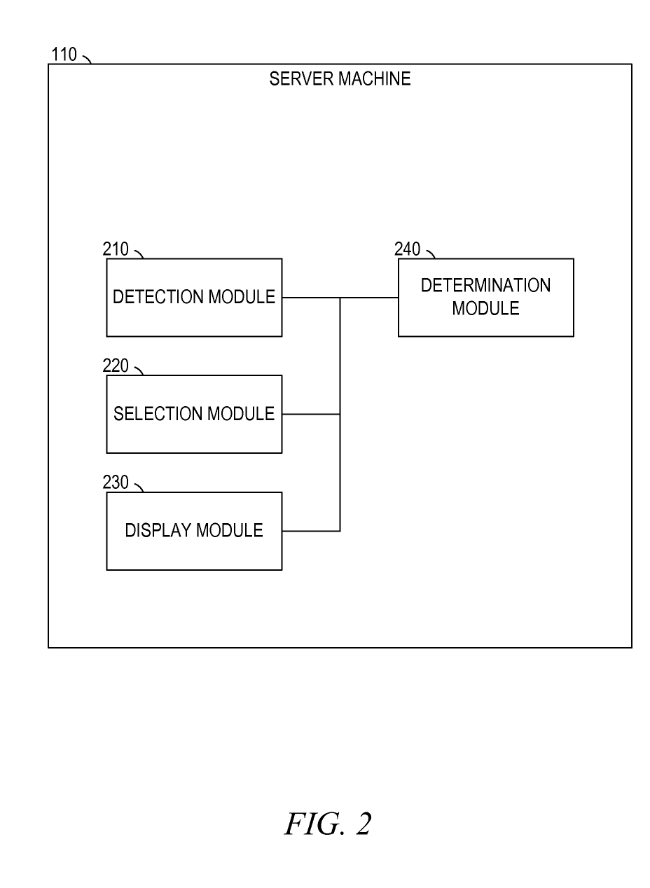

FIG. 2 is a block diagram illustrating components of the server machine 110, according to some example embodiments. The server machine 110 is shown as including a detection module 210, a selection module 220, a display module 230, and a determination module 240, all configured to communicate with each other (e.g., via a bus, shared memory, or a switch). Any one or more of the modules described herein may be implemented using hardware (e.g., one or more processors of a machine) or a combination of hardware and software. For example, any module described herein may configure a processor (e.g., among one or more processors of a machine) to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

In various example embodiments, the detection module 210 is configured to detect a level of communication between a first user (e.g., user 132) and a second user (e.g., user 142). As further explained below, the level of communication may include frequency or rate of communication, content of communication, urgency of communication, and the like. The first user and the second user may be communicating in a first communication mode which is included in a first communication interface. Examples of communication modes include email, a text messaging service, voice messaging, video conferencing, a threaded discussion, group chat, and the like. Examples of voice messaging may include a phone call or a messaging service that is capable of sending audio data as part of a message. Further, the communication mode is included within a communication interface. In other words, the communication mode may be displayed or implemented in the communication interface. Therefore, the communication interface is displayed on a device in order to facilitate communication in the communication mode. The first communication interface may be displayed on a device (e.g., device 130) which is operated by the first user and a device (e.g., device 140) which is operated by the second user. The first communication interface is associated with the first communication mode. However, in some instances, the first communication interface as displayed on the device operated by the first user will appear differently compared to the first communication interface as displayed on the device operated by the second user.

In some embodiments of determining the level of communication, the detection module 210 is further configured to identify content of the communication between the first user and the second user. In some instances, an urgency of the communication can be determined in the content of the communication (e.g., words or phrases used during the course of communication). Accordingly, the detection module 210 can be further configured to determine the urgency of the communication between the first user and the second user. As another example, if the first and second users are communicating through email, the email can include certain signals which indicate a level of urgency associated with the communication. Conversely, the content of the communication may include certain key phrases or words which indicate that the communication is casual and therefore not as urgent. For example, a casual conversation could include a discussion about a happy hour event after work. In further embodiments, the detection module 210 is configured to identify encrypted content being sent in the communication between the first user and the second user. Further, the encrypted content may be used to signify that the communication is private.

In other embodiments of determining the level of communication, the detection module 210 is further configured to detect a rate of communication between the first user and the second user. The rate of communication may be measured as a number of messages exchanged between the first and second user over a predetermined period of time. The rate of communication may also be measured by a response time of each of the parties to the communication (e.g., the first user and the second user).

In other such embodiments of determining the level of communication, the detection module 210 is further configured to determine that communication criteria are satisfied. The communication criteria indicate conditions associated with switching from one communication mode to another. For example, the communication criteria may indicate a set of conditions which must be met prior to switching from email to a messaging service. For instance, the communication criteria may require the detection module 210 to detect a predetermined number of responses within a predetermined duration of time. The communication criteria may require the detection module 210 to detect a keyword or phrase within the communication between the first user and the second user. The communication criteria may require the detection module 210 to detect duration of the communication as exceeding predetermined threshold duration. Each of the criterions listed above may be a factor in determining whether to switch from one communication mode to another. For examples, each of the criterions may be used as an input to a formula (e.g., combinatorial logic) which is used in making the determination. Further, the communication criteria may be adjusted by the detection module 210. The adjustment may include relaxing the communication criteria thereby making it easier to switch communication modes. Alternatively, the adjustment may include making the communication criteria more stringent thereby making it more difficult to switch communication modes. The adjustment could also be made based on user preferences. For instance, the communication criteria associated with switching to a frequently used messaging service may be relaxed. In some embodiments, the detection module 210 is further configured to identify a third user communicating with the first user and the second user in the first communication mode. In other words, the detection module 210 can identify when more than two individuals are parties to the conversation in the first communication mode. For instance, an email message between the first user and the second user may have a third user copied as an intended recipient of the message. As another example, in a group text message may be exchanged among several participants including the first user, the second user, and the third user.

In various example embodiments, the selection module 220 is configured to select a second communication mode based on the detected level of communication between the first user and the second user in the first communication mode. In some embodiments, the second communication mode is selected by the selection module 220 based on the content of the communication between the first user and the second user. For instance, the second communication mode can be more suitable for urgent communications between the first and second user. In further embodiments, the second communication mode is selected by the selection module 220 based on the rate of communication between the first user and the second user. For instance, the second communication mode may be more suitable for frequent exchange of communications between the first and second user. For example, it may be easier for the first and second user to converse over voice rather than through a purely textual messaging service. In further embodiments, the second communication mode is selected by the selection module 220 based on the determination that the communication criteria are satisfied. In further embodiments, the selection module 220 selects the second communication mode based on the detection module 210 identifying the encrypted content. For example, the second communication mode may be more suitable for private conversations between the first and second user.

The second communication mode is distinct from the first communication mode. Moreover, the second communication mode is included in a second communication interface. In other words, the second communication mode may be displayed or implemented in the second communication interface. Therefore, the second communication interface may be displayed on a device in order to facilitate communication in the second communication mode.

In various example embodiments, the selection module 220 is further configured to select the second communication mode based on the identification of the third user. For example, the selection module 220 selects a communication mode that is more suitable for facilitating communication among more than two users. As an example, the selection module 220 may select email as the communication mode for facilitating a business communication among three employees of the business. As another example, the selection module 220 may select a communication mode that is suitable for facilitating communication among a subset of the first, second, and third user. For example, a high ranking officer of a company may be communicating with two employees of the company through email. Moreover, the nature of the email conversation may cause one of the employees to drop out of the conversation. Therefore, the selection module 220 may select voice as the second communication mode and when the conversation switches from email to voice, one of the employees may drop out of the conversation. For example, the selection module 220 may select a voice messaging application which is installed on devices of the higher ranking officer and the employees.

In some embodiments, the selection module 220 is further configured to select the second communication mode based on previous user behavior of at least one of the first user or the second user. For instance, previous user behavior of the first user may indicate a preference for communication over a messaging service (e.g., text messaging). Moreover, the detection module 210 may be further configured to track the previous user behavior of the least one of the first user or the second user. The selection module 220 may select the messaging service as the second communication mode based on the preference. As another example, if the first and second users communicate frequently over email, then the selection module 220 may select the email as being the second communication mode. In other words, the previous user behavior of the first user may indicate a frequency at which the first user communicates over a specific communication mode. Likewise, the previous user behavior of the second user may indicate a frequency at which the second user communicates over a specific communication mode. Further, communication criteria associated with selecting a communication mode may be adjusted based on the previous user behavior of at least one of the first user or the second user. For instance, the communication criteria for a frequently used communication mode may be relaxed or made less stringent. In this way, the selection module 220 is able to select a communication mode that is more frequently used by either the first user or the second user without requiring that all of the communication criteria be satisfied.

In various example embodiments, the display module 230 is configured to cause display of the first communication interface on the device of the first user. Moreover, the display module 230 is configured to cause the device of the first user to switch from the first communication mode to the second communication mode. As stated above, the second communication mode may be included in the second communication interface. Accordingly, the display module 230 is further configured to cause display of the second communication interface on the device of the first user. Likewise, the display module 230 is further configured to cause display of the second communication interface on a device of the second user. In the case that the third user is identified, the display module 230 is further configured to cause display of the second communication interface on a device of the third user. Further, the second communication interface is associated with the second communication mode. However, in some instances, the second communication interface will appear differently on each device.

In some instances, the display module 230 is further configured to cause display of the content of the communication from the first communication interface in the second communication interface. In other words, the content of the communication that appears in the first communication interface also appears in the second communication interface. In some instances, the display module 230 is further configured to rearrange the content of the communication from the first communication interface. The display module 230 may modify a position of the content of the communication from the first communication interface based on a format of the second communication interface. As an example, the format of the second communication interface can display messaging content in a position that is different than the first communication interface. Moreover, the display module 230 may be further configured to change the appearance of the content (e.g., font size, color, and the like) as shown in the first communication interface based on a format of the second communication interface. Thereafter, the display module 230 may cause display of the rearranged content in the second communication interface.

In further embodiments, the display module 230 causes the device of the second user to switch from the first communication mode to the second communication mode. Moreover, the display module 230 also causes the device of the third user to switch from the first communication mode to the second communication mode in the event that the third user is identified as communicating with the first user and the second user. Accordingly, the display module 230 causes display of the second communication interface to at least one of the device of the second user or the device of the third user. As stated above, a high ranking officer of a company may be communicating with two employees of the company, and when the conversation switches from email to voice, one of the employees may drop out of the conversation. Therefore, the contents of voice conversation may be kept hidden from at least one of the device of the second user or the device of the third user.

In various example embodiments, the determination module 240 is configured to determine device capabilities of the device of the first user. For instance, the determination module 240 may identify specifications of the device of the first user (e.g., screen size, processor speed, and the like). Further, the determination module 240 may identify software that is installed on the device of the first user.

In various example embodiments, the determination module 240 is further configured to verify that the device of the first user is compatible with the second communication mode based on the determined device capabilities. Further, the display module 230 may cause the device of the first user to switch from the first communication mode to the second communication mode based on the verification that the device of the first user is compatible with the second communication mode. As an example, the second communication mode may only be compatible with a certain version of an operating system. Alternatively, for optimal experience, the second communication mode may require a minimum screen size on which to display the second communication interface.

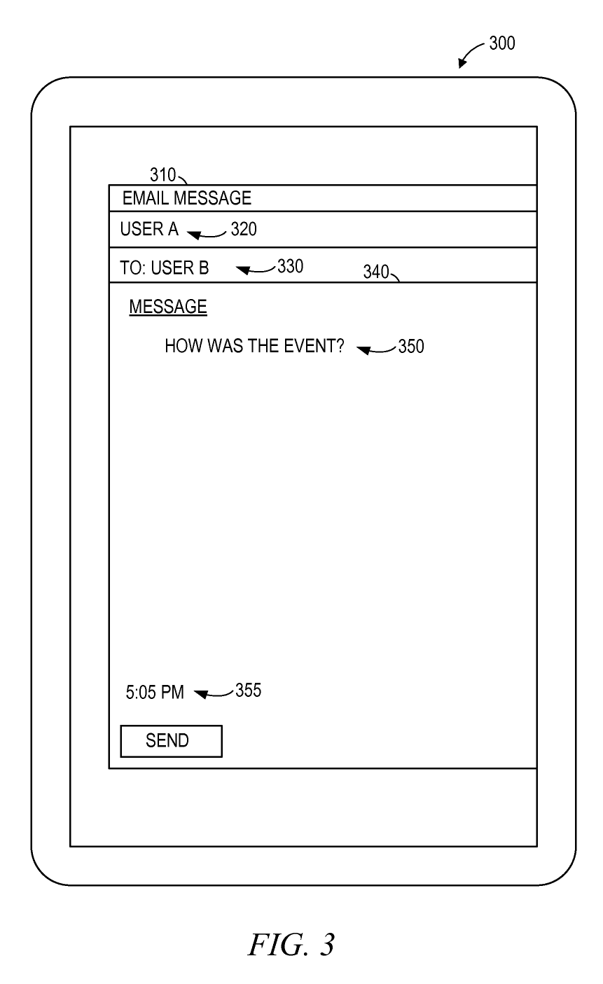

FIG. 3 is an example user interface 300 that displays a communication interface 310, according to some example embodiments. The example user interface 300 may be displayed on a user device. The communication interface 310 may be used to display a communication mode (e.g., email). In other words, the communication mode is shown as included within the communication interface 310. As shown in FIG. 3, the communication interface 310 is an email interface that is used to send and receive emails. The communication interface 310 includes a message 340 that is being sent from a first user 320 to a second user 330. Both of the first user 320 and the second user 330 are shown in the communication interface 310. The communication 340 also includes content 350 which is being sent from the first user 320 to the second user 330. The communication interface 310 may also include a timestamp 355 which indicates when the message is being sent from the first user 320 to the second user 330.

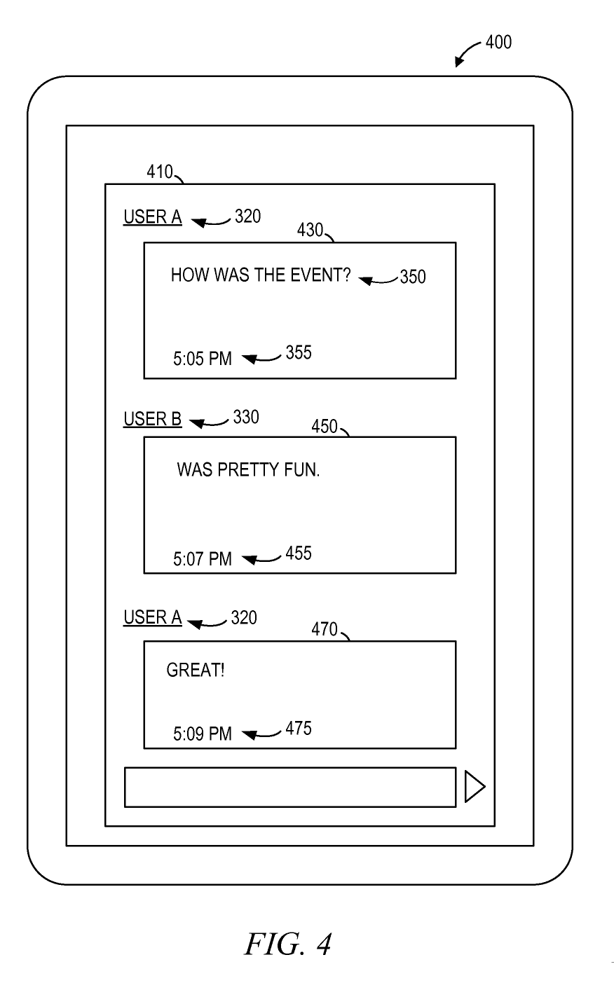

FIG. 4 is an example user interface 400 that displays a communication interface 410, according to some example embodiments. The example user interface 400 may be displayed on a user device. The communication interface 410 is separate and distinct from the communication interface 310 that was shown in FIG. 3. As shown in FIG. 4, the communication interface 410 is a messaging service that can be used to exchange messages between the first user 320 and the second user 330. More specifically, the communication interface 410 includes a first message 430, a second message 450, and a third message 470 each being exchanged between the first user 320 and the second user 330. Moreover, included in the first message 430 is the content 350 that was originally sent from the first user 320 as part of the communication interface 310 of FIG. 3. The timestamp 355 that appears in the communication interface 310 is also shown in the first message 430. As shown, the content 350 is rearranged in the communication interface 410 as part of a messaging interface. Further, a timestamp 455 is being used to indicate when the second message 450 is being sent. A timestamp 475 is being used to indicate when the third message 470 is being sent. The display module 230 may cause the communication interface 410 to be displayed on the user device. Moreover, the communication interface 310 of FIG. 3 may have previously been displayed on the user device. As stated above, the display module 230 causes a switch from a first communication mode to a second communication mode. Moreover, as an example, the detection module 210 may detect that the content 350 is social or casual and therefore the display module 230 causes the switch from email to the messaging service.

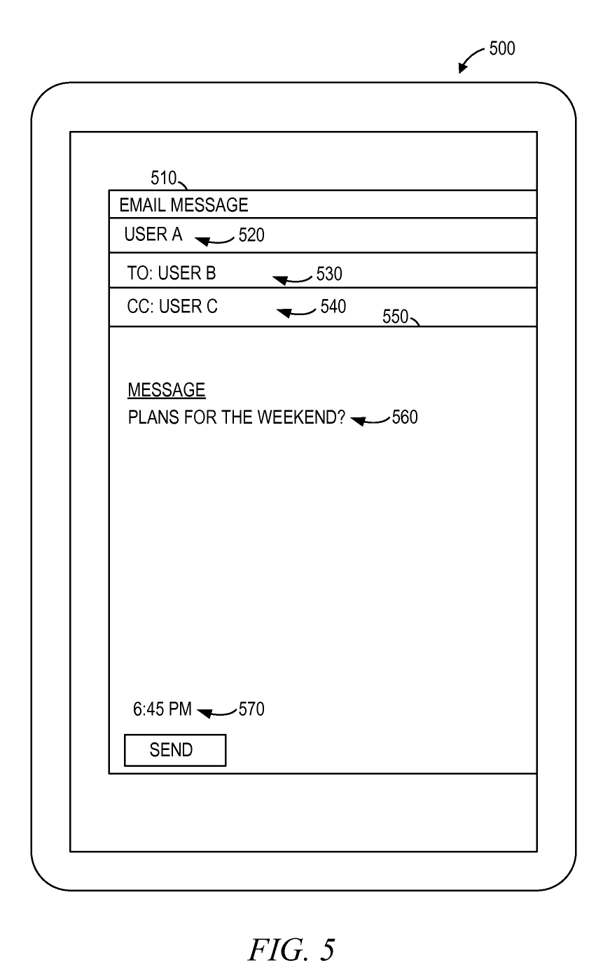

FIG. 5 is an example user interface 500 that displays a communication interface 510, according to some example embodiments. The example user interface 500 may be displayed on a user device. The communication interface 510 may be used to display a communication mode (e.g., email). In other words, the communication mode is shown as included within the communication interface 510. The communication interface 510 includes a message 550 that is being sent from a first user 520 to a second user 530 and a third user 540. Each of the first user 520, the second user 530, and the third user 540 is also shown within the communication interface 510. The message 550 includes content 560 which is being sent from the first user 520 to the second user 530 and the third user 540. Further, the message 550 includes a timestamp 570 which indicates when the message 550 is being sent from the first user 520 to the second user 530 and the third user 540.

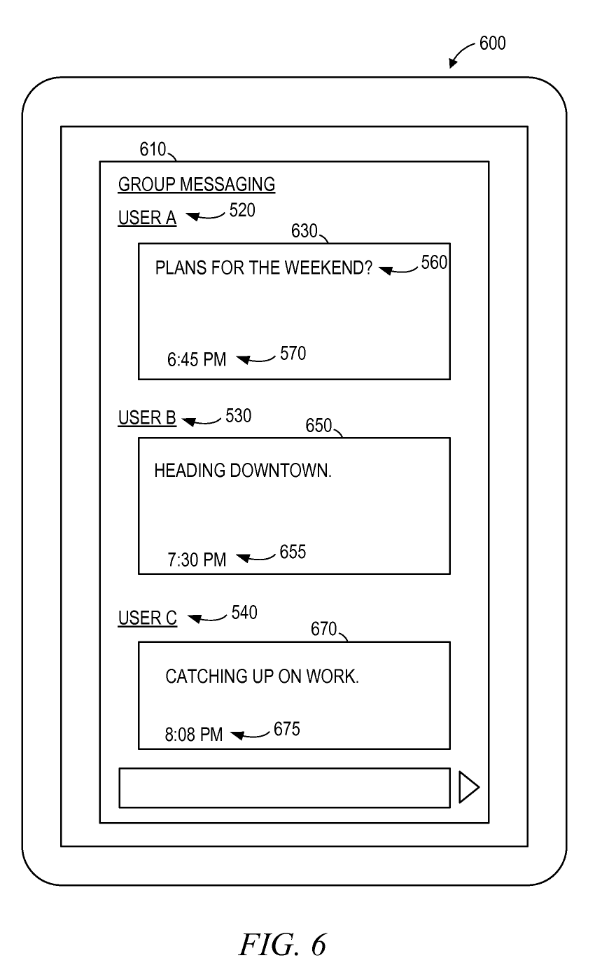

FIG. 6 is an example user interface 600 that displays a communication interface 610, according to some example embodiments. The example user interface 500 may be displayed on a user device. The communication interface 610 is separate and distinct from the communication interface 510 that was shown in FIG. 5. As shown in FIG. 6, the communication interface 610 is a group messaging service that can be used to exchange messages between one or more users. In particular, the communication interface 610 is being used to facilitate communication between the first user 520, the second user 530, and the third user 540. The communication interface 610 displays a first message 630, a second message 650, and a third message 670. The first message 630 may also include the content 560 that was originally sent to the second and third users as part of the communication interface 510 of FIG. 5. The second message 650 is sent from the second user 530 to each of the first user 520 and the third user 540. The third message 670 is sent from the third user 540 to each of the first user 520 and the second user 530. Moreover, the first message 630 includes the timestamp 570 that was also shown in FIG. 5. Further, a timestamp 655 is being used to indicate when the second message 650 is being sent. A timestamp 675 is being used to indicate when the third message 670 is being sent. The display module 230 may cause the communication interface 610 to be displayed on the user device. Moreover, the communication interface 510 of FIG. 5 may have previously been displayed on the user device. Moreover, as an example, the detection module 210 may detect that the content 560 is social or casual and therefore the display module 230 causes the switch from email to the messaging service.

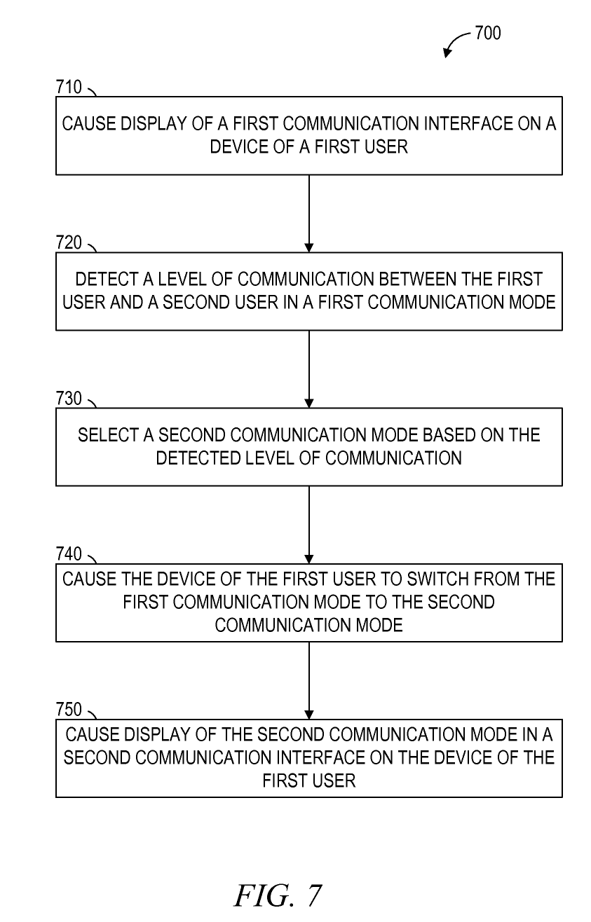

FIG. 7-9 are flowcharts illustrating operations of the server machine 110 in performing a method 700 of causing a switch from a first communication mode to a second communication mode, according to some example embodiments. Operations in the method 700 may be performed by the server machine 110, using modules described above with respect to FIG. 2. As shown in FIG. 7, the method 600 includes operations 710, 720, 730, 740, and 750.

At operation 710, the display module 230 causes display of a first communication interface on a device of a first user. The first communication interface may include a first communication mode to facilitate communication between the first user and the second user. For example, the first communication interface could be a messaging interface that is displayed on the device of the first user in order to allow the first user to send messages for a messaging service. Moreover, the display module 230 may provide display data that is used to produce a display of the first communication interface on the device of the first user.

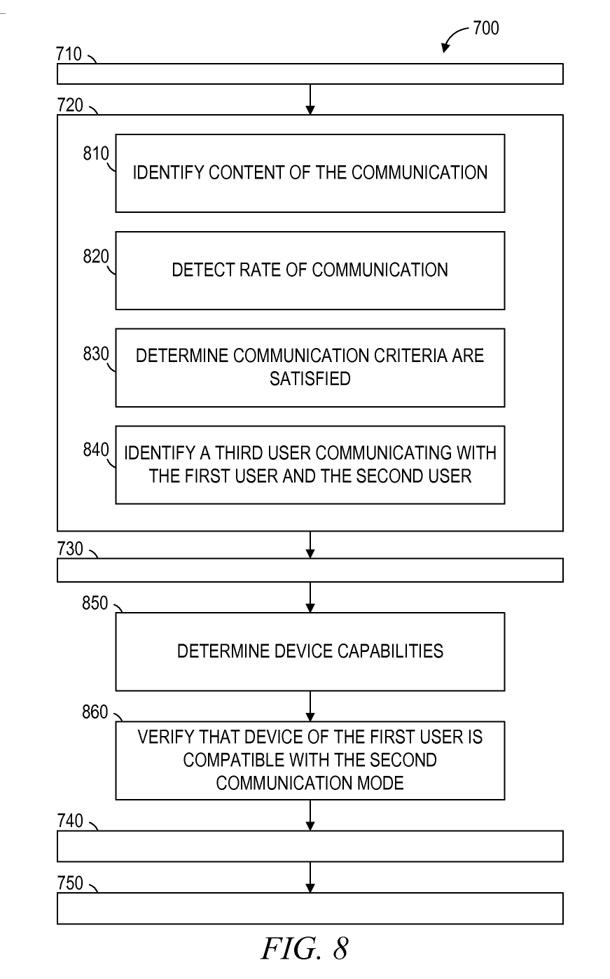

At operation 720, the detection module 210 detects a level of communication between the first user and a second user in a first communication mode. As shown in FIG. 8, the detecting the level of communication between the first user and the second user may include various operations. As stated above, communications exchanged between the first user and the second user in the first communication mode may be sent over the network 190.

At operation 730, the selection module 220 selects a second communication mode based on a detected level of communication. The second communication mode may be more suitable for the first user and the second user based on the detected level of communication. As an example, a conversation regarding private matters may be more appropriate through voice or a video chat.

At operation 740, the display module 230 causes the device of the first user to switch from the first communication mode to the second communication mode. As stated previously, this may relieve a burden on behalf of the user of manually switching communication modes. Moreover, the contents of the communication from the first communication mode may be transferred to the second communication mode. In some instances, the display module 230 causes display of an option which enables a user to select and trigger the switch from the first communication mode to the second communication mode.

At operation 750, the display module 230 causes display of the second communication mode in a second communication interface on the device of the first user. In some instances, the display module 230 also causes display of the content of the communication from the first communication interface in the second communication interface.

As shown in FIG. 8, the method 700 may include one or more of operations 810, 820, 830, 840, 850, and 860. Operations 810-840 may be performed as part of the operation 720.

At operation 810, the detection module 210 identifies content of the communication between the first user and the second user. As stated above, an urgency of the communication can be determined in the content of the communication (e.g., words or phrases used during the course of communication). Accordingly, the detection module 210 can determine the urgency of the communication.

At operation 820, the detection module 210 detects a rate of communication between the first user and the second user. The rate of communication may be measured as a number of messages exchanged between the first user and second user over a predetermined period of time. The rate of communication may also be measured by a response time of each of the parties to the communication.

At operation 830, the detection module 210 determines that communication criteria are satisfied. The communication criteria indicate conditions associated with switching from one communication mode to another.

At operation 840, the detection module 210 identifies a third user communicating with the first user and the second user. For instance, an email between the first user and the second user may have a third user copied as an intended recipient of the message.

At operation 850, the determination module 240 determines device capabilities of the device of the first user. The device capabilities may include device specifications. The device capabilities may also include software installed on the device.

At operation 860, the determination module 240 verifies that the device of the first user is compatible with the second communication mode. The determination module 240 may perform the operation 860 based on the determined device capabilities of the operation 850.

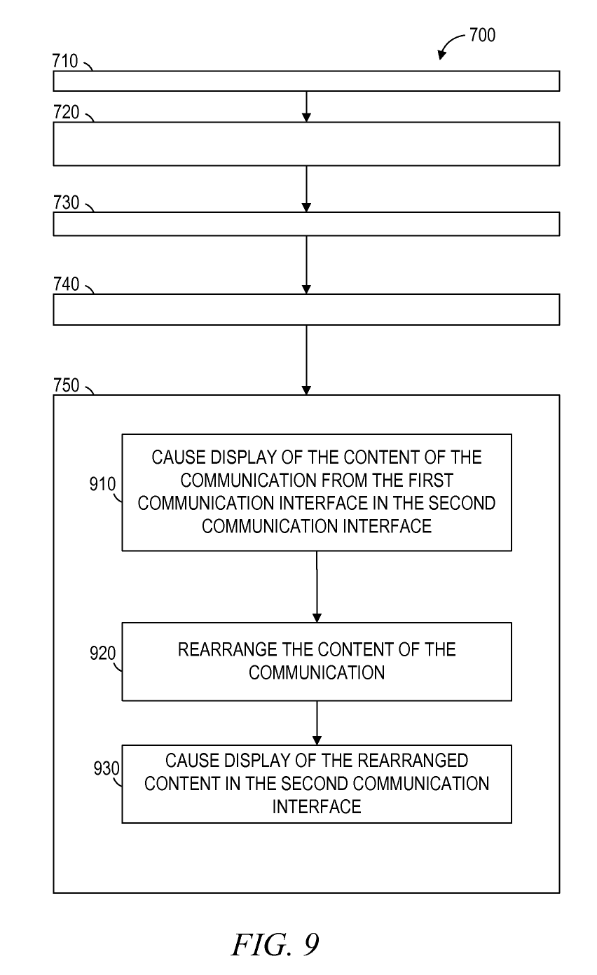

As shown in FIG. 9, the method 700 may include one or more of operations 910, 920, and 930. Operations 910-930 may be performed as part of the operation 750.

At operation 910, the display module 230 causes display of the content of the communication from the first communication interface in the second communication interface.

At operation 920, the display module 230 rearranges the content of the communication from the first communication interface. This may include modifying a position of the content of the communication from the first communication interface based on a format of the second communication interface. This also may include changing the appearance of the content as shown in the first communication interface (e.g., font size, color, and the like) based on the format of the second communication interface.

At operation 930, the display module 230 causes display of the rearranged content in the second communication interface.

When these effects are considered in aggregate, one or more of the methodologies described herein may obviate a need for certain efforts or resources that otherwise would be involved in manually switching communication interfaces. Efforts expended by a user in manually switching communication interfaces may be reduced by one or more of the methodologies described herein. Computing resources used by one or more machines, databases, or devices (e.g., within the network environment 100) may similarly be reduced. Examples of such computing resources include processor cycles, network traffic, memory usage, data storage capacity, power consumption, and cooling capacity.

FIG. 10 is a block diagram illustrating components of a machine 1000, according to some example embodiments, able to read instructions 1024 from a machine-readable medium 1022 (e.g., a non-transitory machine-readable medium, a machine-readable storage medium, a computer-readable storage medium, or any suitable combination thereof) and perform any one or more of the methodologies discussed herein, in whole or in part. Specifically, FIG. 10 shows the machine 1000 in the example form of a computer system (e.g., a computer) within which the instructions 1024 (e.g., software, a program, an application, an applet, an app, or other executable code) for causing the machine 1000 to perform any one or more of the methodologies discussed herein may be executed, in whole or in part.

In alternative embodiments, the machine 1000 operates as a standalone device or may be connected (e.g., networked) to other machines. In a networked deployment, the machine 1000 may operate in the capacity of a server machine or a client machine in a server-client network environment, or as a peer machine in a distributed (e.g., peer-to-peer) network environment. The machine 1000 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 1024, sequentially or otherwise, that specify actions to be taken by that machine. Further, while only a single machine is illustrated, the term “machine” shall also be taken to include any collection of machines that individually or jointly execute the instructions 1024 to perform all or part of any one or more of the methodologies discussed herein.

The machine 1000 includes a processor 1002 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1004, and a static memory 1006, which are configured to communicate with each other via a bus 1008. The processor 1002 may contain microcircuits that are configurable, temporarily or permanently, by some or all of the instructions 1024 such that the processor 1002 is configurable to perform any one or more of the methodologies described herein, in whole or in part. For example, a set of one or more microcircuits of the processor 1002 may be configurable to execute one or more modules (e.g., software modules) described herein.

The machine 1000 may further include a graphics display 1010 (e.g., a plasma display panel (PDP), a light emitting diode (LED) display, a liquid crystal display (LCD), a projector, a cathode ray tube (CRT), or any other display capable of displaying graphics or video). The machine 1000 may also include an alphanumeric input device 1012 (e.g., a keyboard or keypad), a cursor control device 1014 (e.g., a mouse, a touchpad, a trackball, a joystick, a motion sensor, an eye tracking device, or other pointing instrument), a storage unit 1016, an audio generation device 1018 (e.g., a sound card, an amplifier, a speaker, a headphone jack, or any suitable combination thereof), and a network interface device 1020.

The storage unit 1016 includes the machine-readable medium 1022 (e.g., a tangible and non-transitory machine-readable storage medium) on which are stored the instructions 1024 embodying any one or more of the methodologies or functions described herein. The instructions 1024 may also reside, completely or at least partially, within the main memory 1004, within the processor 1002 (e.g., within the processor's cache memory), or both, before or during execution thereof by the machine 1000. Accordingly, the main memory 1004 and the processor 1002 may be considered machine-readable media (e.g., tangible and non-transitory machine-readable media). The instructions 1024 may be transmitted or received over the network 190 via the network interface device 1020. For example, the network interface device 1020 may communicate the instructions 1024 using any one or more transfer protocols (e.g., hypertext transfer protocol (HTTP)).

In some example embodiments, the machine 1000 may be a portable computing device, such as a smart phone or tablet computer, and have one or more additional input components 1030 (e.g., sensors or gauges). Examples of such input components 1030 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1022 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 1024 for execution by the machine 1000, such that the instructions 1024, when executed by one or more processors of the machine 1000 (e.g., processor 1002), cause the machine 1000 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Furthermore, the tangible machine-readable medium is non-transitory in that it does not embody a propagating signal. However, labeling the tangible machine-readable medium as “non-transitory” should not be construed to mean that the medium is incapable of movement—the medium should be considered as being transportable from one physical location to another. Additionally, since the machine-readable medium is tangible, the medium may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. As used herein, “processor-implemented module” refers to a hardware module in which the hardware includes one or more processors. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations. As used herein, the term “or” may be construed in either an inclusive or exclusive sense.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
detecting a level of communication between a first user and a second user in a first communication mode, the first communication mode included in a first communication interface displayed on a device of the first user;
selecting, using one or more processors, a second communication mode based on the detected level of communication between the first user and the second user in the first communication mode; and
causing the device of the first user to switch from the first communication mode to the second communication mode included in a second communication interface, the second communication mode to facilitate communication between the first user and the second user.

2. The method of claim 1, wherein the causing the device of the first user to switch from the first communication mode to the second communication mode includes causing display of the second communication interface on the device of the first user.

3. The method of claim 2, wherein the causing the display of the second communication interface includes causing display of the content of the communication from the first communication interface in the second communication interface.

4. The method of claim 1, wherein the detecting the level of communication between the first user and the second user includes identifying the content of the communication.

5. The method of claim 1, wherein the detecting the level of communication between the first user and the second user includes detecting a rate of communication between the first user and the second user.

6. The method of claim 1, wherein the detecting the level of communication between the first user and the second user includes determining that communication criteria are satisfied.

7. The method of claim 1, wherein the detecting the level of communication between the first user and the second user includes identifying a third user communicating with the first user and the second user in the first communication mode.

8. The method of claim 1, wherein the selecting the second communication mode is further based on previous user behavior of at least one of the first user or the second user.

9. The method of claim 1, further comprising:
determining device capabilities of the device of the first user; and
verifying that the device of the first user is compatible with the second communication mode based on the determined device capabilities, and wherein the causing the device of the first user to switch from the first communication mode to the second communication mode is based on the verification.

10. The method of claim 1, wherein the communication mode includes at least one of: email, a text messaging service, voice messaging, video conferencing, a threaded discussion, or group chat.

11. A system comprising:
a detection module comprising one or more processors configured to detect a level of communication between a first user and a second user in a first communication mode, the first communication mode included in a first communication interface displayed on a device of the first user;
a selection module configured to select a second communication mode based on the detected level of communication between the first user and the second user in the first communication mode; and
a display module configured to cause the device of the first user to switch from the first communication mode to the second communication mode included in a second communication interface, the second communication mode to facilitate communication between the first user and the second user.

12. The system of claim 11, wherein the display module is further configured to cause display of the second communication interface on the device of the first user.

13. The system of claim 12, wherein the display module is further configured to cause display of the content of the communication from the first communication interface in the second communication interface.

14. The system of claim 11, wherein the detection module is further configured to identify the content of the communication.

15. The system of claim 11, wherein the detection module is further configured to detect a rate of communication between the first user and the second user.

16. The system of claim 11, wherein the detection module is further configured to determine that communication criteria are satisfied.

17. The system of claim 11, wherein the detection module is further configured to identify a third user communicating with the first user and the second user in the first communication mode.

18. The system of claim 11, wherein the selection module is further configured to select the second communication mode based on previous user behavior of at least one of the first user or the second user.

19. The system of claim 11, further comprising:
a determination module configured to:
determine device capabilities of the device of the first user; and
verify that the device of the first user is compatible with the second communication mode based on the determined device capabilities, and
wherein the display module is further configured to cause the device of the first user to switch based on the verification.

20. A non-transitory machine-readable medium storing instructions that, when executed by one or more processors of a machine, cause the machine to perform operations comprising:
detecting a level of communication between a first user and a second user in a first communication mode, the first communication mode included in a first communication interface displayed on a device of the first user;
selecting a second communication mode based on the detected level of communication between the first user and the second user in the first communication mode; and
causing the device of the first user to switch from the first communication mode to the second communication mode included in a second communication interface, the second communication mode to facilitate communication between the first user and the second user.
